(19) United States
(12) Patent Application Publication
(10) Pub. No.: US 2020/0177364 A1
(43) Pub. Date: Jun. 4, 2020

(54) DETERMINING DATA PROCESSING MODEL PARAMETERS THROUGH MULTIPARTY COOPERATION

(71) Applicant: Alibaba Group Holding Limited, George Town (KY)

(72) Inventors: Yashun Zhou, Hangzhou (CN); Lichun Li, Hangzhou (CN); Shan Yin, Hangzhou (CN); Huazhong Wang, Hangzhou (CN)

(73) Assignee: Alibaba Group Holding Limited, George Town (KY)

(21) Appl. No.: 16/779,524

(22) Filed: Jan. 31, 2020

Related U.S. Application Data
(63) Continuation of application No. PCT/CN2020/072079, filed on Jan. 14, 2020.

(30) Foreign Application Priority Data
Aug. 9, 2019 (CN) 201910734791.3

(51) Int. Cl. H04L 9/00; G06N 20/00

(52) U.S. Cl. CPC H04L 9/001; G06Q 10/101; G06N 20/00

(57) ABSTRACT

Implementations this specification provide a method and an apparatus for determining data processing model parameters through multiparty cooperation. An example method performed by a data party device includes secretly sharing a first product with a cooperation partner device, based on characteristic data and a share of an original model parameter; communicating with the cooperation partner device, based on the share of the first product and a garbled circuit corresponding to an activation function, to obtain a share of a value of the activation function; secretly sharing a gradient of a loss function with the cooperation partner device, based on the characteristic data and the share of the value of the activation function, to obtain a share of the gradient of the loss function; and computing a share of a new model parameter.

### CROSS-REFERENCE TO RELATED APPLICATIONS

This application is a continuation of PCT Application No. PCT/CN2020/072079, filed on Jan. 14, 2020, which claims priority to Chinese Patent Application No. 201910734791.3, filed on Aug. 9, 2019, and each application is hereby incorporated by reference in its entirety.

### TECHNICAL FIELD

Implementations of the present specification relate to the field of computer technologies, and in particular, to a method and an apparatus for determining a model parameter, and an electronic device.

### BACKGROUND

In the big data era, there are a lot of data silos. Data is usually dispersed between different enterprises. Due to a competition relationship between the enterprises, complete mutual trustiness does not exist among these enterprises in consideration of privacy protection. Sometimes, secure cooperative modeling needs to be conducted among the enterprises, so that a data processing model can be cooperatively trained by using multiparty data on the premise of full privacy protection of enterprise data.

When the data processing model is cooperatively trained, a model parameter of the data processing model can be optimized and adjusted for a plurality of times by using a model parameter optimization method. A technical problem currently to be resolved is how to cooperatively determining a model parameter of a data processing model on the premise of protecting data privacy when the data for training the data processing model is dispersed to a plurality of parties for cooperation modeling.

### SUMMARY

Implementations of the present specification aim at providing a method and an apparatus for determining a model parameter, and an electronic device, so that a model parameter of a data processing model can be determined through multiparty cooperation on the premise of protecting data privacy.

To achieve the previous objective, one or more implementations of the present specification provide the following technical solutions:

According to a first aspect of one or more implementations of the present specification, a method for determining a model parameter is provided. The method is applied to a first data party and includes: secretly sharing a first product with a cooperation partner based on characteristic data and a share of an original model parameter, to obtain a share of the first product, where the first product is a product of the characteristic data and the original model parameter; communicating with the cooperation partner based on the share of the first product and a garbled circuit corresponding to an activation function, to obtain a share of a value of the activation function; secretly sharing a gradient of a loss function with the cooperation partner based on the characteristic data and the share of the value of the activation function, to obtain a share of the gradient of the loss function; and computing a share of a new model parameter based on the share of the original model parameter, the share of the gradient of the loss function, and a predetermined step.

According to a second aspect of one or more implementations of the present specification, a method for determining a model parameter is provided. The method is applied to a second data party and includes: secretly sharing a first product with a cooperation partner based on a share of an original model parameter, to obtain a share of the first product, where the first product is a product of characteristic data and the original model parameter; communicating with the cooperation partner based on the share of the first product and a garbled circuit corresponding to an activation function, to obtain a share of a value of the activation function; secretly sharing a gradient of a loss function with the cooperation partner based on a label and the share of the value of the activation function, to obtain a share of the gradient of the loss function; and computing a share of a new model parameter based on the share of the original model parameter, the share of the gradient of the loss function, and a predetermined step.

According to a third aspect of one or more implementations of the present specification, an apparatus for determining a model parameter is provided. The apparatus is applied to a first data party and includes: a first product share acquisition unit, configured to secretly share a first product with a cooperation partner based on characteristic data and a share of an original model parameter, to obtain a share of the first product, where the first product is a product of the characteristic data and the original model parameter; an activation function value share acquisition unit, configured to communicate with the cooperation partner based on the share of the first product and a garbled circuit corresponding to an activation function, to obtain a share of a value of the activation function; a loss function gradient share acquisition unit, configured to secretly share a gradient of a loss function with the cooperation partner based on the characteristic data and the share of the value of the activation function, to obtain a share of the gradient of the loss function; and a model parameter share computation unit, configured to compute a share of a new model parameter based on the share of the original model parameter, the share of the gradient of the loss function, and a predetermined step.

According to a fourth aspect of one or more implementations of the present specification, an apparatus for determining a model parameter is provided. The apparatus is applied to a second data party and includes: a first product share acquisition unit, configured to secretly share a first product with a cooperation partner based on a share of an original model parameter, to obtain a share of the first product, where the first product is a product of characteristic data and the original model parameter; an activation function value share acquisition unit, configured to communicate with the cooperation partner based on the share of the first product and a garbled circuit corresponding to an activation function, to obtain a share of a value of the activation function; a loss function gradient share acquisition unit, configured to secretly share a gradient of a loss function with the cooperation partner based on a label and the share of the value of the activation function, to obtain a share of the gradient of the loss function; and a model parameter share computation unit, configured to compute a share of a new model parameter based on the share of the original model parameter, the share of the gradient of the loss function, and a predetermined step.

According to a fifth aspect of one or more implementations of the present specification, an electronic device is provided and includes a memory, configured to store a computer instruction; and a processor, configured to execute the computer instruction to implement steps of the method according to the first aspect.

According to a sixth aspect of one or more implementations of the present specification, an electronic device is provided and includes a memory, configured to store a computer instruction; and a processor, configured to execute the computer instruction to implement steps of the method according to the second aspect.

It can be seen from the technical solutions provided in the implementations of the present specification that, in the implementations of the present specification, the first data party and the second data party can cooperatively determine a model parameter of a data processing model by using a gradient descent method on the premise of protecting their own data by combining secretly sharing and a garbled circuit.

### BRIEF DESCRIPTION OF DRAWINGS

To describe technical solutions in implementations of the present specification or in the existing technology more clearly, the following briefly describes the accompanying drawings required for describing the implementations or the existing technology. Apparently, the accompanying drawings in the following descriptions merely show some implementations of the present specification, and a person of ordinary skill in the art can still derive other drawings from these accompanying drawings without creative efforts.

FIG. 1 is a schematic diagram illustrating a logic circuit, according to an implementation of the present specification;

FIG. 2 is a schematic diagram illustrating a system for determining a model parameter, according to an implementation of the present specification;

FIG. 3 is a flowchart illustrating a method for determining a model parameter, according to an implementation of the present specification;

FIG. 4 is a schematic diagram illustrating computation by using a garbled circuit, according to an implementation of the present specification;

FIG. 5 is a flowchart illustrating a method for determining a model parameter, according to an implementation of the present specification;

FIG. 6 is a flowchart illustrating a method for determining a model parameter, according to an implementation of the present specification;

FIG. 7 is a schematic structural diagram illustrating functions of an apparatus for determining a model parameter, according to an implementation of the present specification;

FIG. 8 is a schematic structural diagram illustrating functions of an apparatus for determining a model parameter, according to an implementation of the present specification; and

FIG. 9 is a schematic structural diagram illustrating functions of an electronic device, according to an implementation of the present specification.

### DESCRIPTION OF IMPLEMENTATIONS

The following clearly describes the technical solutions in the implementations of the present specification with reference to the accompanying drawings in the implementations of the present specification. Apparently, the described implementations are merely some rather than all of the implementations of the present specification. All other implementations obtained by a person of ordinary skill in the art based on the implementations of the present specification without creative efforts shall fall within the protection scope of the present specification.

The secure multi-party computation (MPC) is an algorithm for protecting data privacy security. Based on the secure MPC, a plurality of data parities participating in the computation can perform cooperative computation without leaking their own data.

The secret sharing (SS) is an algorithm for protecting data privacy security and can be used to implement the secure MPC. The plurality of data parties can perform cooperative computation by using the SS algorithm to obtain secret information without leaking their own data. Each data party can obtain a share of the secret information. A single data party cannot restore the secret information. The secret information can be restored only through cooperation of the plurality of data parties. For example, a data party P₁ holds data x₁, and a data party P₂ holds data X₂. Based on the SS algorithm, the data party P₁ and the data party P₂ can perform cooperative computation to obtain the secret information. After the computation, the data party P₁ can obtain a share y₁ of the secret information y, and the data party P₂ can obtain a share y₂ of the secret information y.

The garbled circuit (GC) is a secure computation protocol for protecting data privacy and can be used to implement the secure MPC. A given computation task (for example, a function) can be transferred to a logic circuit. The logic circuit can consist of at least one logic gate. The logic gates can include an AND gate, an OR gate, an XOR gate, etc. The logic circuit can include at least two input lines and at least one output line. At least one of the input line or the output line of the logic circuit can be encrypted to obtain the GC. The plurality of data parties can perform cooperative computation by using the GC without leaking their own data, to obtain an execution result of the computation task.

The oblivious transfer (OT) is a communications protocol in which communications parties can obliviously transfer data to each other to protect privacy. The sender can have a plurality of pieces of data. The receiver can obtain one or more of the plurality of pieces of data through OT. In this process, the sender does not know which data the receiver receives, and the receiver cannot obtain any other data than the received data. The OT protocol is a basic protocol for the GC. The OT protocol is usually used during the cooperation computation performed by using the GC.

The following describes an application scenario example of the GC.

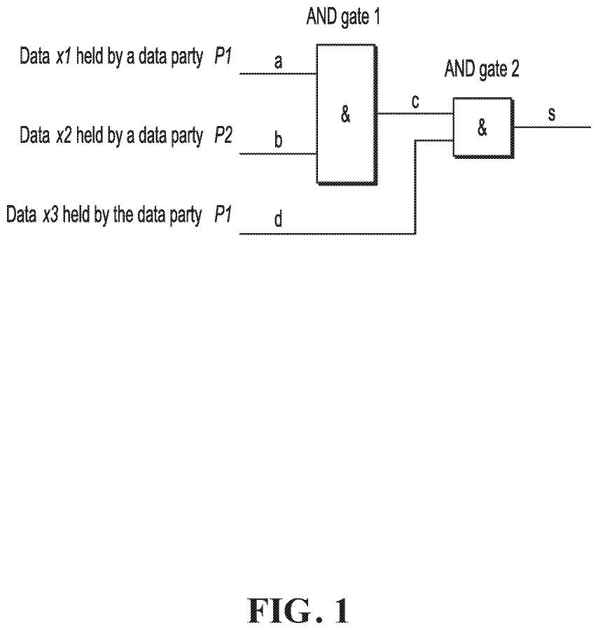

For example, a data party P₁ holds data x₁ and data x₃, and a data party P₂ holds data x₂. The function y=f(x₁, x₂, x₃)=x₁x₂x₃ can be expressed as the logic circuit shown in FIG. 1. The logic circuit consists of an OR gate 1 and an OR gate 2. The logic circuit can include an input line a, an input line b, an input line d, an output line c, and an output line s.

The following describes a process in which the data party P₁ generates a garbled truth table of the OR gate 1.

The truth table corresponding to the OR gate 1 can be shown in Table 1.

TABLE 1

| a | b | c |
|---|---|---|
| 0 | 0 | 0 |
| 0 | 1 | 0 |
| 1 | 0 | 0 |
| 1 | 1 | 1 |

The data party P₁ can generate two random numbers kₐ⁰ and kₐ¹ respectively corresponding to two input values 0 and 1 of the input line a; two random numbers k_{b}⁰ and k_{b}¹ respectively corresponding to two input values 0 and 1 of the input line b; or two random numbers k_{c}⁰ and k_{c}¹ respectively corresponding to two output values 0 and 1 of the output line c. In this case, a random truth table shown in Table 2 can be obtained.

TABLE 2

| a | b | c |
|---|---|---|
| kₐ⁰ | k_{b}⁰ | k_{c}⁰ |
| kₐ⁰ | k_{b}¹ | k_{c}⁰ |
| kₐ¹ | k_{b}⁰ | k_{c}⁰ |
| kₐ¹ | k_{b}¹ | k_{c}¹ |

The data party P₁ can encrypt the random number k_{c}⁰ by respectively using the random numbers kₐ⁰ and k_{b}⁰ as keys, to obtain a random number ciphertext Eₖ_{ₐ}_{⁰}(Eₖ_{_{b}}_{⁰}(k_{c}⁰)); encrypt the random number k_{c}⁰ by respectively using the random numbers kₐ⁰ and k_{b}⁰ as keys, to obtain a random number ciphertext Eₖ_{ₐ}_{⁰}(Eₖ_{_{b}}_{¹}(k_{c}⁰); encrypt the random number k_{c}⁰ by respectively using the random numbers kₐ¹ and k_{b}⁰ as keys, to obtain a random number ciphertext Eₖ_{ₐ}_{¹}(Eₖ_{_{b}}_{⁰}(k_{c}⁰)); or encrypt the random number k_{c}¹ by respectively using the random numbers kₐ¹ and k_{b}¹ as keys, to obtain a random number ciphertext Eₖ_{ₐ}_{¹}(Eₖ_{_{b}}_{¹}(k_{c}¹)). In this case, an encrypted random truth table shown in Table 3 can be obtained.

TABLE 3

| A | b | c |
|---|---|---|
| kₐ⁰ | k_{b}⁰ | Eₖ_{ₐ}_{⁰}(Eₖ_{_{b}}_{⁰}(k_{c}⁰)) |
| kₐ⁰ | k_{b}¹ | Eₖ_{ₐ}_{⁰}(Eₖ_{_{b}}_{¹}(k_{c}⁰)) |
| kₐ¹ | k_{b}⁰ | Eₖ_{ₐ}_{¹}(Eₖ_{_{b}}_{⁰}(k_{c}⁰)) |
| kₐ¹ | k_{b}¹ | Eₖ_{ₐ}_{¹}(Eₖ_{_{b}}_{¹}(k_{c}¹)) |

The data party P₁ can change the order of rows in Table 3, to obtain a garbled truth table shown in Table 4.

TABLE 4

| a | b | c |
|---|---|---|
| kₐ¹ | k_{b}⁰ | Eₖ_{ₐ}_{¹}(Eₖ_{_{b}}_{⁰}(k_{c}⁰)) |
| kₐ⁰ | k_{b}¹ | Eₖ_{ₐ}_{⁰}(Eₖ_{_{b}}_{¹}(k_{c}⁰)) |
| kₐ¹ | k_{b}¹ | Eₖ_{ₐ}_{¹}(Eₖ_{_{b}}_{¹}(k_{c}¹)) |
| kₐ⁰ | k_{b}⁰ | Eₖ_{ₐ}_{⁰}(Eₖ_{_{b}}_{⁰}(k_{c}¹)) |

The data party P₁ can further generate a garbled truth table of the OR gate 2. A detailed process is similar to the process of generating the garbled truth table of the OR gate 1. Details are omitted here for simplicity.

The data party P₁ can send the garbled truth table of the OR gate 1 and the garbled truth table of the OR gate 2 to the data party P₂. The data party P₂ can receive the garbled truth table of the OR gate 1 and the garbled truth table of the OR gate 2.

The data party P₁ can send a random number corresponding to each bit of the data x₁ on the input line a to the data party P₂; and send a random number corresponding to each bit of the data x₃ on the input line d to the data party P₂. The data party P₂ can receive the random number corresponding to each bit of the data x₁ and the data x₃. For example, data x₁=b₀×2⁰+b₁×2¹+ . . . +bᵢ×2ⁱ+ . . . . For the ith bit bᵢ of the data x₁, when bᵢ is equal to 0, the data party P₁ can send a random number kₐ⁰ corresponding to bᵢ on the input line a to the data party P₂; when bᵢ is equal to 1, the data party P₁ can send a random number kₐ¹ corresponding to bᵢ on the input line a to the data party P₂.

The data party P₁ can use the random numbers k_{d}⁰ and k_{d}¹ as an input, and the data party P₂ can use each bit of the data x₂ as an input. The two parties perform OT. The data party P₂ can obtain the random number corresponding to each bit of the data x₂. The data party P₁ can generate the two random numbers k_{d}⁰ and k_{d}¹ respectively corresponding to the two input values 0 and 1 of the input line d. As such, for each bit of the data x₂, the data party P₁ can use the random numbers k_{d}⁰ and k_{d}¹ as secret information input during the OT, and the data party P₂ can use the bit as selected information input during the OT, to perform the OT. Through the OT, the data party P₂ can obtain a random number corresponding to the bit on the input line d. When the bit is equal to 0, the data party P₂ can obtain the random number k_{d}¹; when the bit is equal to 1, the data party P₂ can obtain the random number k_{d}⁰. Considering the characteristic of the OT, the data party P₁ does not know which random number the data party P₂ selects, and the data party P₂ does not know any other random number than the selected random number.

Through the previous process, the data party P₂ obtains the random number corresponding to each bit of the data x₁, the data x₂, and the data x₃. As such, the data party P₂ can try to decrypt the four random number ciphertexts in the garbled truth table of the OR gate 1 by using the random number corresponding to each bit of the data x₁ on the input line a and the random number corresponding to each bit of the data x₂ on the input line b. The data party P₂ can successfully decrypt only one of the random number ciphertexts to obtain one random number on the output line c. Then, the data party P₂ can try to decrypt the four random number ciphertexts in the garbled truth table of the OR gate 2 by using the random number corresponding to each bit of the data x₃ on the input line d and the random number obtained after the decryption on the output line c. The data party P₂ can successfully decrypt only one of the random number ciphertexts to obtain one random number on the output line s. The data party P₂ can send the random number obtained after the decryption on the output line s to the data party P₁. The data party P₁ can receive the random number on the output line s, and can obtain an output value on the output line s based on the random number on the output line s and a correspondence between a random number and an output value.

Each output value on the output line s can be considered as one bit of a value of the function y=f(x₁, x₂, x₃)=x₁x₂x₃. As such, the data party P₁ can determine a value of the function y=f(x₁, x₂, x₃)=x₁x₂x₃ based on a plurality of output values on the output line s.

The loss function can be used to measure a degree of inconsistence between a prediction value of the data processing model and a truth value. The smaller value of the loss function indicates the better robustness of the data processing model. The loss function includes but is not limited to a logarithmic loss function, a square loss function, etc.

The activation function can be used to construct a data processing model. When an input is specified, an output is defined by using the activation function. The activation function is usually a nonlinear function. A nonlinear factor can be added in the data processing model by using the activation function, to improve an expression capability of the data processing model. The activation function can include a Sigmoid function, a Tanh function, a ReLU function, etc. The data processing model can include a logistic regression model, a neural network model, etc.

In a secure cooperative modeling scenario, to protect data privacy, a plurality of data parties can cooperatively train the data processing model based on data held by themselves without leaking the data. The data processing model includes but is not limited to a logistic regression model, a neural network model, etc. When the data processing model is trained, model parameters of the data processing model can be optimized and adjusted by using a model parameter optimization method. The model parameter optimization method can include a gradient descent method. The gradient descent method can include an original gradient method and various variant methods based on the original gradient method (for example, a batch gradient descent method and a regularized gradient descent method, where the regularized gradient descent method is a gradient descent method with regularization through which complexity and instability of a model can be reduced to alleviate an over-fitting risk). Therefore, if a plurality of parties for the cooperation modeling cooperatively determine a model parameter of the data processing model through the secure MPC by using the gradient descent method, the data processing model can be trained on the premise of protecting data privacy of the parties for the cooperation modeling.

The secure MPC can be implemented through SS or by using the GC. The activation function in the data processing model is usually a nonlinear function which relates to nonlinear computation. As a result, the value of the activation function cannot be obtained through computation by directly using the SS algorithm. A polynomial is needed to fit the activation function if the model parameter of the data processing model is cooperatively determined through only the SS by using the gradient descent method. When the polynomial is used to fit the activation function, an out-of-bounds problem exists (when an input of the polynomial exceeds a certain range, an output of the polynomial becomes very large or small). Consequently, it is possible that the data processing model cannot be trained successfully. In addition, because the GC is very complex, the process of training the data processing model becomes very complex if the model parameter of the data processing model is cooperatively determined by using only the GC and the gradient descent method. In consideration of this, by combining the SS and the GC, the out-of-bounds problem can be avoided, and the complexity of the process of training the data processing model can be reduced.

The present specification provides an implementation of a system for determining a model parameter.

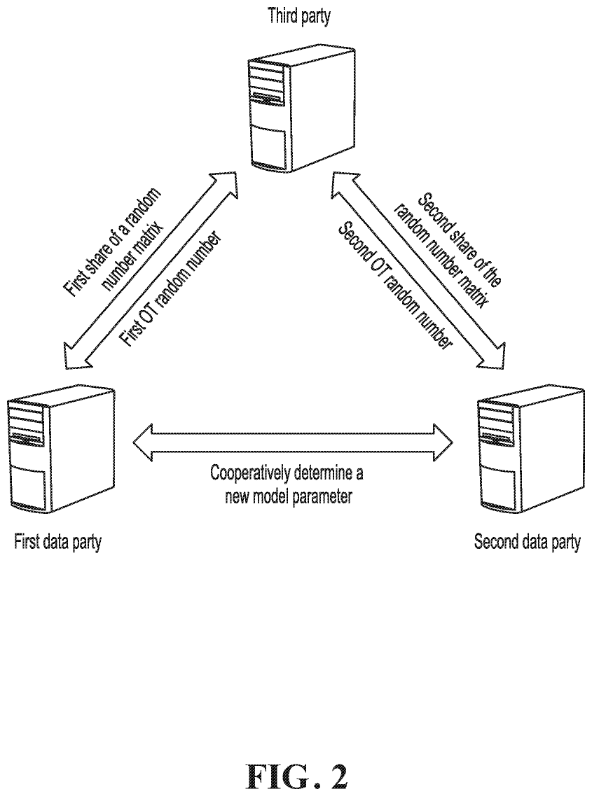

With reference to FIG. 2, in the implementation, the system for determining a model parameter can include a first data party, a second data party, and a trusted third party (TTP).

The third party can be a server or a server cluster including a plurality of servers. The third party is used to provide a random number for the first data party and the second data party. The third party can generate a random number matrix; divide each random number in the random number matrix into two shares; and use one of the two shares as a first share, and use the other of the two shares as a second share. The third party can use a matrix formed by a first share of each random number in the random number matrix as a first share of the random number matrix, and use a matrix formed by a second share of each random number in the random number matrix as a second share of the random number matrix. The third party can send the first share of the random number matrix to the first data party, and the third party can send the second share of the random number matrix to the second data party. A sum of the first share of the random number matrix and the second share of the random number matrix is equal to the random number matrix. In addition, the third party can further generate a first OT random number and a second OT random number because the first data party and the second data party conduct the OT in a process of performing computation by using a GC. The third party can send the first OT random number to the first data party, and send the second OT random number to the second data party. The OT random number can be a random number used in the OT process.

The first data party and the second data party are two parties in secure cooperative modeling. The first data party can hold characteristic data, and the second data party can hold a label. For example, the first data party can hold complete characteristic data, and the second data party can hold a label of the characteristic data. Alternatively, the first data party can hold a part of characteristic data, and the second data party can hold the other part of the characteristic data and a label of the characteristic data. For example, the characteristic data can include a deposit amount and a loan amount of a user. The first data party can hold the deposit amount of the user, and the second data party can hold the loan amount of the user and a label corresponding to the characteristic data. The label can be used to distinguish between different types of characteristic data. A specific value of the label can be, for example, 0 or 1. It is worthwhile to note that the data party here can be an electronic device. The electronic device can include a personal computer, a server, a handheld device, a portable device, a tablet device, and a multi-processor apparatus; or include a cluster including any previous apparatuses or devices. In addition, the characteristic data and the label corresponding to the characteristic data constitute sample data, and the sample data can be used to train the data processing model.

In a secure cooperative modeling scenario, the first data party and the second data party each can obtain a share of an original model parameter. Here, the share obtained by the first data party can be used as a first share of the original model parameter, and the share obtained by the second data party can be used as a second share of the original model parameter. A sum of the first share of the original model parameter and the second share of the original model parameter is equal to the original model parameter.

The first data party can receive the first share of the random number matrix and the first OT random number. The second data party can receive the second share of the random number matrix and the second OT random number. As such, the first data party and the second data party can cooperatively determine a new model parameter by combining the SS and the GC based on the first share of the original model parameter, the characteristic data, the first share of the random number matrix, the first OT random number, the second share of the original model parameter, the label value, the second share of the random number matrix, and the second OT random number. The first data party and the second data party each can obtain a share of a new model parameter. For a detailed process, reference can be made to the following implementation of a method for determining a model parameter.

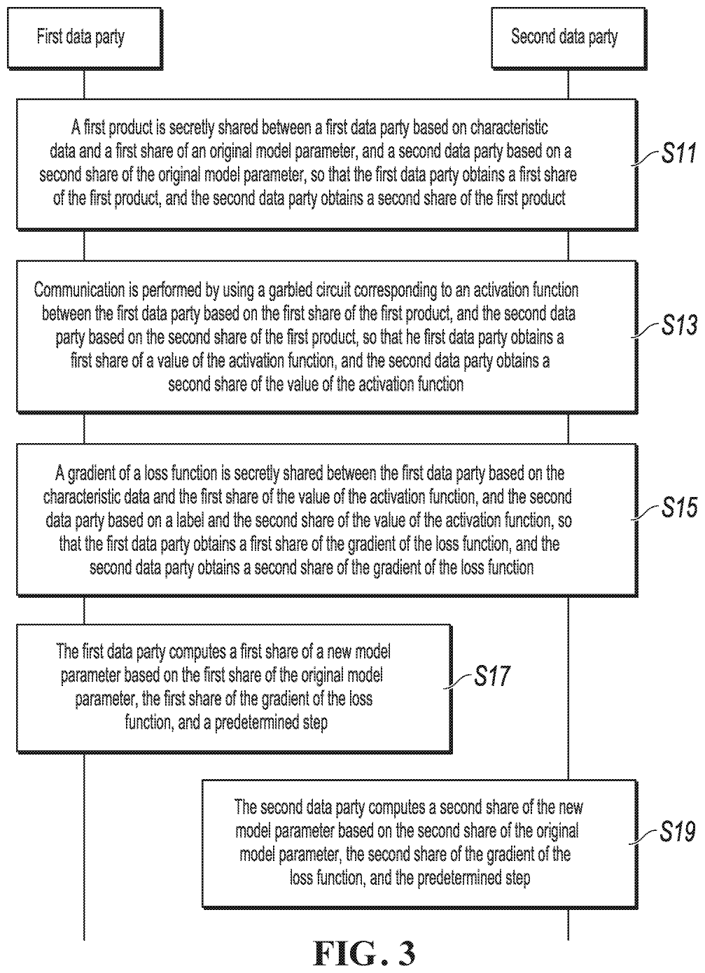

The present specification provides an implementation of a method for determining a model parameter. In the implementation, a model parameter can be determined by using a gradient descent method. With reference to FIG. 3, the implementation can include the following steps.

Step S11: A first product is secretly shared between a first data party based on characteristic data and a first share of an original model parameter, and a second data party based on a second share of the original model parameter. The first data party obtains a first share of the first product, and the second data party obtains a second share of the first product.

Step S13: Communication is performed by using a GC corresponding to an activation function between the first data party based on the first share of the first product, and the second data party based on the second share of the first product. The first data party obtains a first share of a value of the activation function, and the second data party obtains a second share of the value of the activation function.

Step S15: A gradient of a loss function is secretly shared between the first data party based on the characteristic data and the first share of the value of the activation function, and the second data party based on a label and the second share of the value of the activation function. The first data party obtains a first share of the gradient of the loss function, and the second data party obtains a second share of the gradient of the loss function.

Step S17: The first data party computes a first share of a new model parameter based on the first share of the original model parameter, the first share of the gradient of the loss function, and a predetermined step.

Step S19: The second data party computes a second share of the new model parameter based on the second share of the original model parameter, the second share of the gradient of the loss function, and the predetermined step.

In some implementations, the first product can be a product of the original model parameter and the characteristic data. In some scenario examples, the first product can be represented as XW. Here, W represents the original model parameter, which is a vector formed by the original model parameter; and X represents the characteristic data, which is a matrix formed by the characteristic data.

In Step S11, the first product can be secretly shared between the first data party based on the characteristic data and the first share of the original model parameter, and the second data party based on the second share of the original model parameter. The first data party and the second data party each can obtain a share of the first product. For ease of description, the share obtained by the first data party can be used as the first share of the first product, and the share obtained by the second data party can be used as the second share of the first product. A sum of the first share of the original model parameter and the second share of the original model parameter is equal to the original model parameter. A sum of the first share of the first product and the second share of the first product is equal to the first product.

Still in the previous scenario example, the first share of the original model parameter can be represented as <W>₀, and the second share of the original model parameter can be represented as <W>₁, where <W>₀+<W>₁=W. The first product XW can be secretly shared between the first data party based on X and <W>₀, and the second data party based on the <W>₁. The first data party can obtain the first share <XW>₀ of the first product, and the second data party can obtain the second share <XW>₁ of the first product. <XW>₀+<XW>₁=XW.

In some implementations, a corresponding logic circuit can be constructed based on the activation function. The logic circuit can be constructed by the first data party, or by the second data party, or by another device (for example, a TTP). The logic circuit can consist of at least one logic gate. The logic gates can include an AND gate, an OR gate, an XOR gate, etc. The logic circuit can include at least two input lines and at least one output line. At least one of the input line or the output line of the logic circuit can be encrypted to obtain the GC. The GC can include a garbled truth table of each operation gate in the logic circuit. It is worthwhile to note that the logic circuit can be directly constructed based on the activation function. Alternatively, the activation function can be properly transformed, and the logic circuit can be constructed based on the transformed activation function. Alternatively, another function can be generated based on the activation function, and the logic circuit can be constructed based on the another function. Correspondingly, the activation function corresponds to the GC can be understood as follows: The GC is generated based on a logic circuit of the activation function, or the GC is generated based on a logic circuit of a transformed activation function, or the GC is generated based on a logic circuit of another function.

Both the first data party and the second data party can hold the GC corresponding to the activation function. In some implementations, the GC can be generated by the first data party. The first data party can send the generated GC to the second data party. The second data party can receive the GC. In some other implementations, the GC can be alternatively generated by the second data party. The second data party can send the generated GC to the first data party. The first data party can receive the GC.

In Step S13, communication can be performed by using the GC corresponding to the activation function between the first data party based on the first share of the first product, and the second data party based on the second share of the first product. The first data party and the second data party each can obtain a share of a value of the activation function. For ease of description, the share obtained by the first data party can be used as the first share of the value of the activation function, and the share obtained by the second data party can be used as the second share of the value of the activation function. A sum of the first share of the value of the activation function and the second share of the value of the activation function is equal to the value of the activation function.

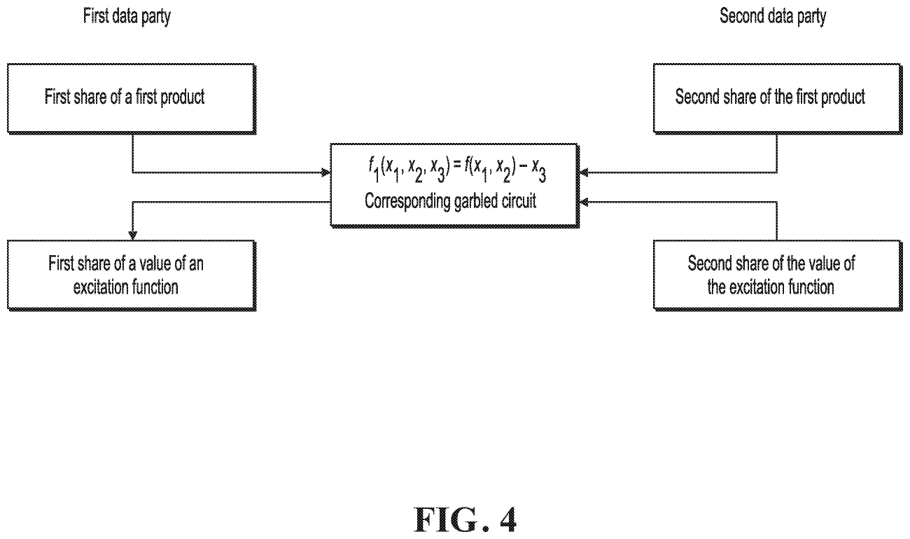

With reference to FIG. 4, the following describes a scenario example in which the first data party and the second data party perform computation by using the GC.

The function y=f₁(x₁, x₂, x₃)=f(x₁, x₂)−x₃ can be constructed based on the activation function f(x₁, x₂). Here, x₁ is used to represent the first share of the first product, x₂ is used to represent the second share of the first product, x₃ is used to represent the share of the value of the activation function (which is referred to the second share of the value of the activation function hereinafter), and a value of f₁(x₁, x₂, x₃) is used to represent the other share of the value of the activation function (which is referred to as the first share of the value of the activation function hereinafter).

A logic circuit corresponding to the function f₁(x₁, x₂, x₃)=f(x₁, x₂)−x₃ can be constructed. A GC can be obtained by encrypting at least one of an input line or an output line of the logic circuit. Both the first data party and the second data party can hold the GC. It is worthwhile to note that the function y=f₁(x₁, x₂, x₃)=f(x₁, x₂)−x₃ and the logic circuit corresponding to the function can be constructed by the first data party, or by the second data party, or by another device (for example, a TTP).

The second data party can generate a share of the value of the activation function as the second share. As such, the first data party can use the first share of the first product as an input of the GC, and the second data party can use the second share of the first product and the second share of the value of the activation function as an input of the GC, to conduct communication. The first data party can obtain the other share of the value of the activation function through computation by using the GC, and use the other share as the first share. For a detailed computation process, reference can be made to the previous scenario example for describing a GC. Details are omitted here for simplicity.

In some implementations, to reduce the complexity of the GC, a piecewise linear function can be used to fit the activation function. As such, the corresponding logic circuit can be constructed based on the piecewise linear function. The GC can be obtained by encrypting at least one of an input line or an output line of the logic circuit. Both the first data party and the second data party can hold the GC. For example, the activation function can be a Sigmoid function, and the piecewise linear function can be

$$y = f ( x ) = \{ \begin{matrix}1 & x \geq \frac{0.5}{k} \\ kx + 0.5 & - \frac{0.5}{k} < x < \frac{0.5}{k} \\ 0 & x \leq - \frac{0.5}{k}\end{matrix} .$$

Communication can be performed by using the GC between the first data party based on the first share of the first product, and the second data party based on the second share of the first product. The first data party and the second data party each can obtain a share of a value of the piecewise linear function. For ease of description, the share obtained by the first data party can be used as a first share of the value of the piecewise linear function, and the share obtained by the second data party can be used as the second share of the value of the piecewise linear function. A sum of the first share of the value of the piecewise linear function and the second share of the value of the piecewise linear function is equal to the value of the piecewise linear function. As such, the first data party can use the first share of the value of the piecewise linear function as the first share of the value of the activation function. As such, the second data party can use the second share of the value of the piecewise linear function as the second share of the value of the activation function.

In some implementations, in step S15, the gradient of the loss function can be secretly shared between the first data party based on the characteristic data and the first share of the value of the activation function, and the second data party based on the label and the second share of the value of the activation function. The first data party and the second data party each can obtain a share of the gradient of the loss function. For ease of description, the share obtained by the first data party can be used as the first share of the gradient of the loss function, and the share obtained by the second data party can be used as the second share of the gradient of the loss function. The sum of the first share of the gradient of the loss function and the second share of the gradient of the loss function is equal to the gradient of the loss function.

Still in the previous scenario example, the gradient dW (which is a vector) of the loss function can be secretly shared between the first data party based on X and <a>₀, and the second data party based on the label Y and <a>₁. The first data party can obtain the first share <dW>₀ of the gradient of the loss function, and the second data party can obtain the second share <dW>₁ of the gradient of the loss function. The following describes a detailed process in which the first data party and the second data party secretly share the gradient dW of the loss function.

The first data party and the second data party can secretly share X^{T}<a>₁ based on X and <a>₁, respectively. The first data party can obtain <[X^{T}<a>₁]>₀, and the second data party can obtain <[X^{T}<a>₁]>₁<[X^{T}<a>₁]>₀+<[X^{T}<a>₁]>₁=X^{T}<a>₁.

The first data party and the second data party can secretly share X^{T}Y based on X and the label Y (which is a vector formed by the label), respectively. The first data party can obtain <X^{T}Y>₀, and the second data party can obtain <X^{T}Y>₁, <X^{T}Y>₀+<X^{T}Y>₁=X^{T}Y.

The first data party can compute X^{T}<a>₀. The first data party can compute X^{T}<a>₀+<[X^{T}<a>₁]>₀−<X^{T}Y>₀ to obtain the first share <dW>₀ of the gradient dW of the loss function. The second data party can compute <[X^{T}<a>₁]>₁−<X^{T}Y>₁ to obtain the second share <dW>₁ of the gradient dW of the loss function.

$$\begin{matrix}dW = < dW {>}_{0} + < dW {>}_{1} \\ = {X}^{T} < a {>}_{0} + < [ {X}^{T} < a {>}_{1} ] {>}_{0} - < {X}^{T} Y {>}_{0} + \\ < [ {X}^{T} < a {>}_{1} ] {>}_{1} - < {X}^{T} Y {>}_{1} \\ = {X}^{T} < a {>}_{0} + {X}^{T} < a {>}_{1} - {X}^{T} Y \\ = {X}^{T} a - {X}^{T} Y \\ = {X}^{T} ( a - Y )\end{matrix}$$

In some implementations, the predetermined step can be used to control an iteration speed of the gradient descent method. The predetermined step can be any proper positive real number. For example, when the predetermined step is excessively large, the iteration speed becomes excessively fast. Consequently, it is possible that an optimal model parameter cannot be obtained. When the predetermined step is excessively small, the iteration speed becomes excessively slow. Consequently, a long time is consumed. The predetermined step can be an empirical value, or can be obtained by using a machine learning method. Certainly, the predetermined step can also be obtained by using another method. Both the first data party and the second data party can hold the predetermined step.

In step S17, the first data party can multiply the first share of the gradient of the loss function and the predetermined step to obtain the second product, and subtract the second product from the first share of the original model parameter to obtain the first share of the new model parameter.

In step S19, the second data party can multiply the second share of the gradient of the loss function and the predetermined step to obtain a third product, and subtract the third product from the second share of the original model parameter to obtain the second share of the new model parameter. A sum of the first share of the new model parameter and the second share of the new model parameter is equal to the new model parameter.

Still in the previous scenario example, the first data party can multiply the first share <dW>₀ (which is a vector) of the gradient of the loss function and the predetermined step G (which is scalar multiplication of vectors) to obtain the second product G<dW>₀. The second product G<dW>₀ is subtracted from the first share <W>₀ of the original model parameter to obtain the first share <W′>₀=<W>₀−G<dW>₀ of the new model parameter.

The second data party can multiply the second share <dW>₁ (which is a vector) of the gradient of the loss function and the predetermined step G (which is scalar multiplication of vectors) to obtain the third product G<dW>₁. Subtract the second product G<dW>₁ from the second share <W>₁ of the original model parameter to obtain the second share <W′>₁=<W>₁−G<dW>₁ of the new model parameter. Here, <W′>₀+<W′>₁=W′, where W′ represents the new model parameter.

It is worthwhile to note that in practice, the new model parameter can further be used as a new original model parameter, and step S11, step S13, step S15, step S17, and step S19 can be executed again. The method for determining a model parameter in the implementation is executed repeatedly, so that iterative optimization and adjustment can be implemented on the model parameter of the data processing model.

In the implementation, the first data party and the second data party can cooperatively determine the model parameter of the data processing model by using the gradient descent method on the premise of protecting their own data by combining the SS and the GC.

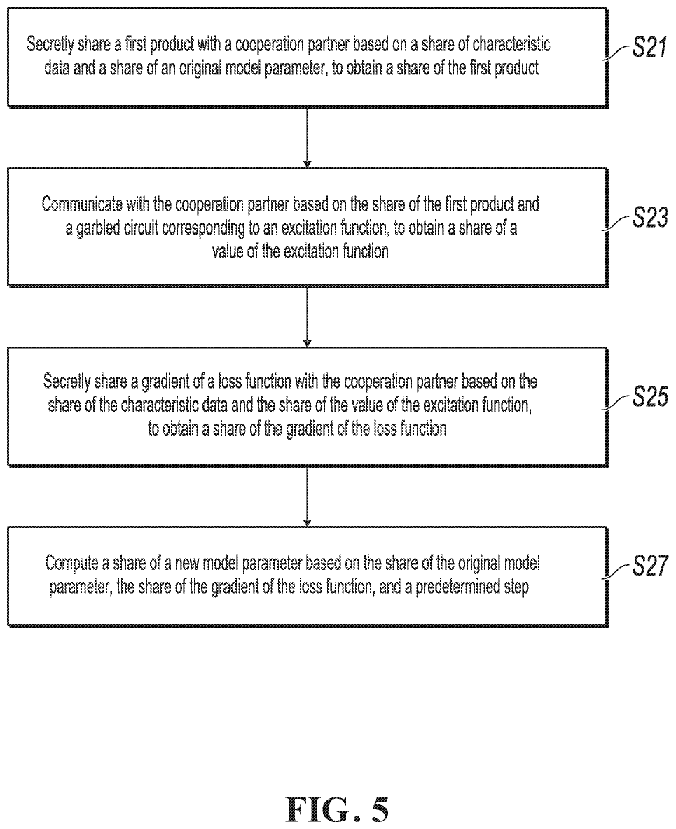

Based on a same inventive concept, the present specification further provides an implementation of another method for determining a model parameter. In the implementation, a first data party is an execution body. The first data party can hold characteristic data and a share of an original model parameter. With reference to FIG. 5, the implementation can include the following steps.

Step S21: Secretly share a first product with a cooperation partner based on characteristic data and a share of an original model parameter, to obtain a share of the first product.

In some implementations, the cooperation partner can be understood as a data party that performs secure cooperative modeling with the first data party. The cooperation partner can be the previous second data party. The first product can be a product of the characteristic data and the original model parameter. The first data party can secretly share the first product with the cooperation partner based on the characteristic data and the share of the original model parameter, to obtain the share of the first product. For a detailed process, reference can be made to the description related to Step S11. Details are omitted here for simplicity.

Step S23: Communicate with the cooperation partner based on the share of the first product and a GC corresponding to an activation function, to obtain a share of a value of the activation function.

In some implementations, the first data party can communicate with the cooperation partner based on the share of the first product and the GC corresponding to the activation function, to obtain the share of the value of the activation function. For a detailed process, reference can be made to the description related to Step S13. Details are omitted here for simplicity.

Step S25: Secretly share a gradient of a loss function with the cooperation partner based on the characteristic data and the share of the value of the activation function, to obtain a share of the gradient of the loss function.

In some implementations, the first data party can secretly share the gradient of the loss function with the cooperation partner based on the characteristic data and the share of the value of the activation function, to obtain the share of the gradient of the loss function. For a detailed process, reference can be made to the description related to Step S15. Details are omitted here for simplicity.

Step S27: Compute a share of a new model parameter based on the share of the original model parameter, the share of the gradient of the loss function, and a predetermined step.

In some implementations, the predetermined step can be used to control an iteration speed of a gradient descent method. The predetermined step can be any proper positive real number. For example, when the predetermined step is excessively large, the iteration speed becomes excessively fast. Consequently, it is possible that an optimal model parameter cannot be obtained. When the predetermined step is excessively small, the iteration speed becomes excessively slow. Consequently, a long time is consumed. The predetermined step can be an empirical value, or can be obtained by using a machine learning method. Certainly, the predetermined step can also be obtained by using another method. The first data party can multiply the share of the gradient of the loss function and the predetermined step to obtain the second product. The second product is subtracted from the share of the original model parameter to obtain the share of the new model parameter. For a detailed process, reference can be made to the description related to Step S17. Details are omitted here for simplicity.

In the implementation, the first data party and the cooperation partner can cooperatively determine the model parameter of the data processing model without leaking their own data by combining the SS and the GC, to obtain the share of the new model parameter.

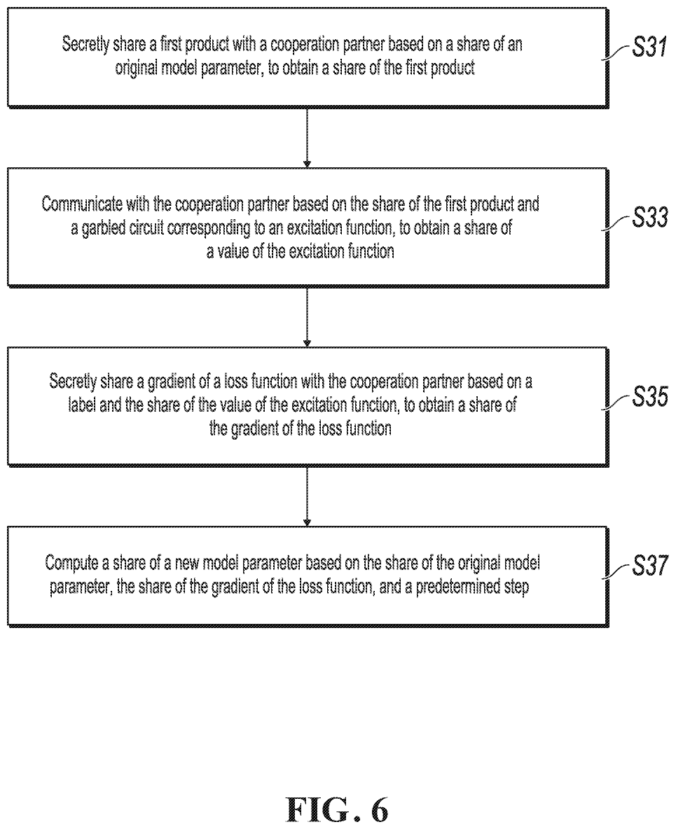

Based on a same inventive concept, the present specification further provides an implementation of another method for determining a model parameter. In the implementation, a second data party is an execution body. The second data party can hold a label and a share of an original model parameter. With reference to FIG. 6, the implementation can include the following steps.

Step S31: Secretly share a first product with a cooperation partner based on a share of an original model parameter, to obtain a share of the first product.

In some implementations, the cooperation partner can be understood as a data party that performs secure cooperative modeling with the second data party. The cooperation partner can be the previous first data party. The first product can be a product of the characteristic data and the original model parameter. The second data party can secretly share the first product with the cooperation partner based on the share of the original model parameter, to obtain the share of the first product. For a detailed process, reference can be made to the description related to Step S11. Details are omitted here for simplicity.

Step S33: Communicate with the cooperation partner based on the share of the first product and a GC corresponding to an activation function, to obtain a share of a value of the activation function.

In some implementations, the second data party can communicate with the cooperation partner based on the share of the first product and the GC corresponding to the activation function, to obtain the share of the value of the activation function. For a detailed process, reference can be made to the description related to Step S13. Details are omitted here for simplicity.

Step S35: Secretly share a gradient of a loss function with the cooperation partner based on a label and the share of the value of the activation function, to obtain a share of the gradient of the loss function.

In some implementations, the second data party can secretly share the gradient of the loss function with the cooperation partner based on the label and the share of the value of the activation function, to obtain the share of the gradient of the loss function. For a detailed process, reference can be made to the description related to Step S15. Details are omitted here for simplicity.

Step S37: Compute a share of a new model parameter based on the share of the original model parameter, the share of the gradient of the loss function, and a predetermined step.

In some implementations, the predetermined step can be used to control an iteration speed of a gradient descent method. The predetermined step can be any proper positive real number. For example, when the predetermined step is excessively large, the iteration speed becomes excessively fast. Consequently, it is possible that an optimal model parameter cannot be obtained. When the predetermined step is excessively small, the iteration speed becomes excessively slow. Consequently, a long time is consumed. The predetermined step can be an empirical value, or can be obtained by using a machine learning method. Certainly, the predetermined step can also be obtained by using another method. The second data party can multiply the share of the gradient of the loss function and the predetermined step to obtain the second product. The second product is subtracted from the share of the original model parameter to obtain the share of the new model parameter. For a detailed process, reference can be made to the description related to Step S17. Details are omitted here for simplicity.

In the implementation, the second data party and the cooperation partner can cooperatively determine the model parameter of the data processing model without leaking their own data by combining the SS and the GC, to obtain the share of the new model parameter.

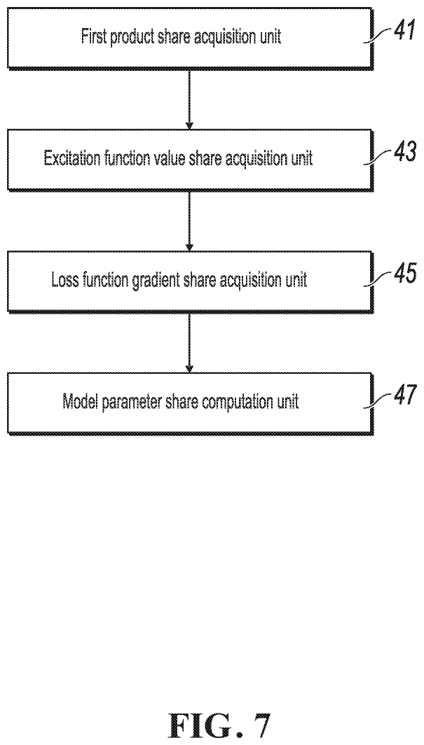

Based on a same inventive concept, the present specification further provides an implementation of an apparatus of determining a model parameter. With reference to FIG. 7, the implementation can be applied to a first data party. The apparatus can include the following units:

A first product share acquisition unit 41 is configured to secretly share a first product with a cooperation partner based on characteristic data and a share of an original model parameter, to obtain a share of the first product, where the first product is a product of the characteristic data and the original model parameter.

An activation function value share acquisition unit 43 is configured to communicate with the cooperation partner based on the share of the first product and a garbled circuit corresponding to an activation function, to obtain a share of a value of the activation function.

A loss function gradient share acquisition unit 45 is configured to secretly share a gradient of a loss function with the cooperation partner based on the characteristic data and the share of the value of the activation function, to obtain a share of the gradient of the loss function.

A model parameter share computation unit 47 is configured to compute a share of a new model parameter based on the share of the original model parameter, the share of the gradient of the loss function, and a predetermined step.

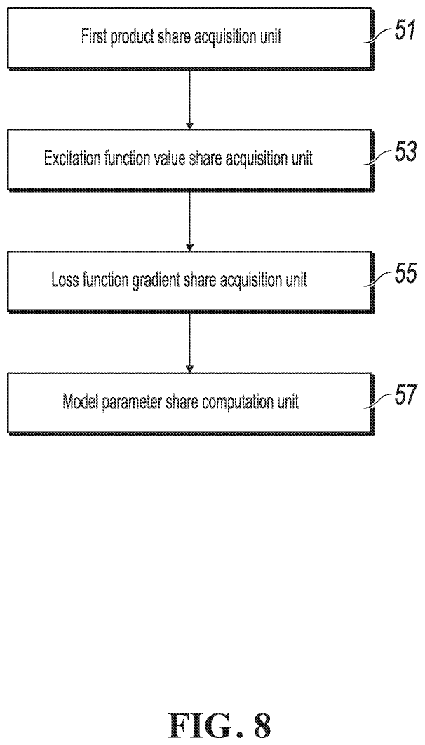

Based on a same inventive concept, the present specification further provides an implementation of an apparatus of determining a model parameter. With reference to FIG. 8, the implementation can be applied to a second data party. The apparatus can include the following units:

A first product share acquisition unit 51 is configured to secretly share a first product with a cooperation partner based on a share of an original model parameter, to obtain a share of the first product, where the first product is a product of the characteristic data and the original model parameter.

An activation function value share acquisition unit 53 is configured to communicate with the cooperation partner based on the share of the first product and a garbled circuit corresponding to an activation function, to obtain a share of a value of the activation function.

A loss function gradient share acquisition unit 55 is configured to secretly share a gradient of a loss function with the cooperation partner based on a label and the share of the value of the activation function, to obtain a share of the gradient of the loss function.

A model parameter share computation unit 57 is configured to compute a share of a new model parameter based on the share of the original model parameter, the share of the gradient of the loss function, and a predetermined step.

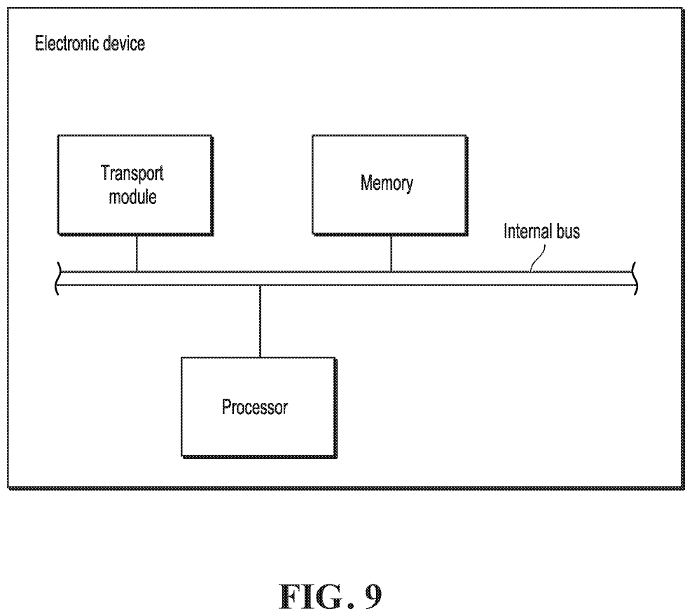

The following describes an implementation of an electronic device in the present specification. FIG. 9 is a schematic structural diagram illustrating hardware of an electronic device, according to the implementation. As shown in FIG. 9, the electronic device can include one or more (only one in the figure) processors, memories, and transport modules. Certainly, a person of ordinary skill in the art can understood that, the hardware structure shown in FIG. 9 is merely an example, which does not constitute limitation to the hardware structure of the electronic device. In practice, the electronic device can include more or less components than units shown in FIG. 9, or have a configuration different from that shown in FIG. 9.

The memory can include a cache, or a nonvolatile storage, for example, one or more magnetic storage apparatuses, flash memories, or other nonvolatile solid-state memories. Certainly, the memory can further include a remotely set network memory. The remotely set network memory can be connected to the electronic device over a network such as the Internet, an intranet, a local area network, or a mobile communication network. The memory can be used to store a program instruction or module of application software, for example, at least one of the program instruction or module in the implementation corresponding to FIG. 5 in the present specification or the program instruction or module in the implementation corresponding to FIG. 6 in the present specification.

The processor can be implemented by using any proper method. For example, the processor can be a microprocessor or a processor, and a computer readable medium storing computer readable program code (for example, software or firmware) executable to the (micro)processor, a logic gate, a switch, an application specific integrated circuit (ASIC), a programmable logic controller, or an embedded microcontroller. The processor can read and execute the program instruction or module in the memory.

The transport module can be used to transmit data over a network, for example, transmit data over a network such as the Internet, an intranet, a local area network, or a mobile communication network.

It is worthwhile to note that the implementations in the present specification are described in a progressive method. For the same or similar parts in the implementations, references can be made to each other. Each implementation focuses on a difference from other implementations. Particularly, an apparatus implementation is basically similar to a method implementation, and therefore, is described briefly. For related parts, reference can be made to related descriptions in the method implementation. In addition, it can be understood that a person skilled in the art can obtain any combination of some or all of the implementations listed in the present specification without creative efforts after reading the present specification. These combinations also fall within the protection scope disclosed in the present specification.

In the 1990s, whether a technical improvement is a hardware improvement (for example, an improvement to a circuit structure, such as a diode, a transistor, or a switch) or a software improvement (an improvement to a method procedure) can be clearly distinguished. However, as technologies develop, current improvements to many method procedures can be considered as direct improvements to hardware circuit structures. A designer usually programs an improved method procedure into a hardware circuit, to obtain a corresponding hardware circuit structure. Therefore, a method procedure can also be improved by using a hardware entity module. For example, a programmable logic device (PLD) (for example, a field programmable gate array (FPGA)) is such an integrated circuit, and a logical function of the PLD is determined by a user through device programming. The designer performs programming to “integrate” a digital system to a PLD without requesting a chip manufacturer to design and produce an application-specific integrated circuit chip. In addition, at present, instead of manually manufacturing an integrated circuit chip, such programming is mostly implemented by using “logic compiler” software. The logic compiler software is similar to a software compiler used to develop and write a program. Original code needs to be written in a particular programming language for compilation. The language is referred to as a hardware description language (HDL). There are many HDLs, such as the Advanced Boolean Expression Language (ABEL), the Altera Hardware Description Language (AHDL), Confluence, the Cornell University Programming Language (CUPL), HDCal, the Java Hardware Description Language (JHDL), Lava, Lola, MyHDL, PALASM, and the Ruby Hardware Description Language (RHDL). The very-high-speed integrated circuit hardware description language (VHDL) and Verilog2 are most commonly used. A person skilled in the art should also understand that a hardware circuit that implements a logical method procedure can be readily obtained once the method procedure is logically programmed by using the several described hardware description languages and is programmed into an integrated circuit.

The system, apparatus, module, or unit illustrated in the previous implementations can be implemented by using a computer chip or an entity, or can be implemented by using a product having a certain function. A typical implementation device is a computer. The computer can be, for example, a personal computer, a laptop computer, a cellular phone, a camera phone, a smartphone, a personal digital assistant, a media player, a navigation device, an email device, a game console, a tablet computer, or a wearable device, or a combination of any of these devices.

It can be seen from the descriptions of the implementations that a person skilled in the art can clearly understand that the present specification can be implemented by using software and a necessary general hardware platform. Based on such an understanding, the technical solutions in the present specification essentially or the part contributing to the existing technology can be implemented in a form of a software product. The computer software product can be stored in a storage medium, such as a ROM/RAM, a magnetic disk, or an optical disc, and includes several instructions for instructing a computer device (can be a personal computer, a server, or a network device) to perform the methods described in the implementations or in some parts of the implementations of the present specification.

The present specification can be applied to many general-purpose or dedicated computer system environments or configurations, for example, a personal computer, a server computer, a handheld device or a portable device, a flat panel device, a multi-processor system, a microprocessor-based system, a set-top box, a programmable consumption electronic device, a network PC, a minicomputer, a mainframe computer, and a distributed computing environment including any one of the previous systems or devices.

The present specification can be described in the general context of computer-executable instructions, for example, a program module. Generally, the program module includes a routine, a program, an object, a component, a data structure, etc. executing a specific task or implementing a specific abstract data type. The present specification can alternatively be practiced in distributed computing environments in which tasks are performed by remote processing devices that are connected through a communications network. In a distributed computing environment, the program module can be located in both local and remote computer storage media including storage devices.

Although the present specification is described by using the implementations, a person of ordinary skill in the art knows that many modifications and variations of the present specification can be made without departing from the spirit of the present specification. It is expected that the claims include these modifications and variations without departing from the spirit of the present specification.

What is claimed is:

1. A computer-implemented method comprising:
secretly sharing a first product, by a data party device and with a cooperation partner device, based on characteristic data and a share of an original model parameter, to obtain a share of the first product, wherein the first product is a product of the characteristic data and the original model parameter;
communicating, by the data party device and with the cooperation partner device, based on the share of the first product and a garbled circuit corresponding to an activation function, to obtain a share of a value of the activation function;
secretly sharing a gradient of a loss function, by the data party device and with the cooperation partner device, based on the characteristic data and the share of the value of the activation function, to obtain a share of the gradient of the loss function; and
computing, by the data party device, a share of a new model parameter based on the share of the original model parameter, the share of the gradient of the loss function, and a predetermined step.

2. The method according to claim 1, wherein communicating with the cooperation partner device, based on the share of the first product and the garbled circuit corresponding to the activation function, comprises:
communicating with the cooperation partner device, based on the share of the first product and a garbled circuit corresponding to a piecewise linear function, to obtain a share of a value of the piecewise linear function as the share of the value of the activation function, wherein the piecewise linear function is used to fit the activation function.

3. The method according to claim 1, wherein computing the share of the new model parameter based on the share of the original model parameter, the share of the gradient of the loss function, and the predetermined step comprises:
multiplying the share of the gradient of the loss function and the predetermined step to obtain a second product; and
subtracting the second product from the share of the original model parameter to obtain the share of the new model parameter.

4. The method according to claim 1, wherein the cooperation partner secretly shares the gradient of the loss function based on a label used to distinguish between different types of characteristic data, and its share of the value of the activation function.

5. The method according to claim 1, wherein the characteristic data constitutes sample data used to train a data processing model.

6. The method according to claim 1, wherein the garbled circuit is a secure computational protocol for protecting data privacy.

7. A computer-implemented system, comprising:
one or more computers; and
one or more computer memory devices interoperably coupled with the one or more computers and having tangible, non-transitory, machine-readable media storing one or more instructions that, when executed by the one or more computers, perform operations comprising:
secretly sharing a first product, by a data party device and with a cooperation partner device, based on characteristic data and a share of an original model parameter, to obtain a share of the first product, wherein the first product is a product of the characteristic data and the original model parameter;
communicating, by the data party device and with the cooperation partner device, based on the share of the first product and a garbled circuit corresponding to an activation function, to obtain a share of a value of the activation function;
secretly sharing a gradient of a loss function, by the data party device and with the cooperation partner device, based on the characteristic data and the share of the value of the activation function, to obtain a share of the gradient of the loss function; and
computing, by the data party device, a share of a new model parameter based on the share of the original model parameter, the share of the gradient of the loss function, and a predetermined step.

8. The system according to claim 7, wherein communicating with the cooperation partner device, based on the share of the first product and the garbled circuit corresponding to the activation function, comprises:
communicating with the cooperation partner device, based on the share of the first product and a garbled circuit corresponding to a piecewise linear function, to obtain a share of a value of the piecewise linear function as the share of the value of the activation function, wherein the piecewise linear function is used to fit the activation function.

9. The system according to claim 7, wherein computing the share of the new model parameter based on the share of the original model parameter, the share of the gradient of the loss function, and the predetermined step comprises:
multiplying the share of the gradient of the loss function and the predetermined step to obtain a second product; and
subtracting the second product from the share of the original model parameter to obtain the share of the new model parameter.

10. The system according to claim 7, wherein the cooperation partner secretly shares the gradient of the loss function based on a label used to distinguish between different types of characteristic data, and its share of the value of the activation function.

11. The system according to claim 7, wherein the characteristic data constitutes sample data used to train a data processing model.

12. The system according to claim 7, wherein the garbled circuit is a secure computational protocol for protecting data privacy.

13. A non-transitory, computer-readable medium storing one or more instructions executable by a computer system to perform operations comprising:
secretly sharing a first product, by a data party device and with a cooperation partner device, based on characteristic data and a share of an original model parameter, to obtain a share of the first product, wherein the first product is a product of the characteristic data and the original model parameter;
communicating, by the data party device and with the cooperation partner device, based on the share of the first product and a garbled circuit corresponding to an activation function, to obtain a share of a value of the activation function;
secretly sharing a gradient of a loss function, by the data party device and with the cooperation partner device, based on the characteristic data and the share of the value of the activation function, to obtain a share of the gradient of the loss function; and
computing, by the data party device, a share of a new model parameter based on the share of the original model parameter, the share of the gradient of the loss function, and a predetermined step.

14. The computer-readable medium according to claim 13, wherein communicating with the cooperation partner device, based on the share of the first product and the garbled circuit corresponding to the activation function, comprises:
communicating with the cooperation partner device, based on the share of the first product and a garbled circuit corresponding to a piecewise linear function, to obtain a share of a value of the piecewise linear function as the share of the value of the activation function, wherein the piecewise linear function is used to fit the activation function.

15. The computer-readable medium according to claim 13, wherein computing the share of the new model parameter based on the share of the original model parameter, the share of the gradient of the loss function, and the predetermined step comprises:
multiplying the share of the gradient of the loss function and the predetermined step to obtain a second product; and
subtracting the second product from the share of the original model parameter to obtain the share of the new model parameter.

16. The computer-readable medium according to claim 13, wherein the cooperation partner secretly shares the gradient of the loss function based on a label used to distinguish between different types of characteristic data, and its share of the value of the activation function.

17. The computer-readable medium according to claim 13, wherein the characteristic data constitutes sample data used to train a data processing model.

18. The computer-readable medium according to claim 13, wherein the garbled circuit is a secure computational protocol for protecting data privacy.
